(19) United States
(12) Patent Application Publication
(10) Pub. No.: US 2022/0103655 A1
(43) Pub. Date: Mar. 31, 2022

(54) PROACTIVELY SELECTING VIRTUAL REALITY CONTENT CONTEXTS

(71) Applicant: International Business Machines Corporation, Armonk, NY (US)

(72) Inventors: Subha Kiran Patnaikuni, Visakhapatnam (IN); Sarbajit K. Rakshit, Kolkata (IN)

(21) Appl. No.: 17/035,783

(22) Filed: Sep. 29, 2020

(51) Int. Cl. H04L 29/06; H04L 12/26

(52) U.S. Cl. CPC H04L 67/38; H04L 43/0882

(57) ABSTRACT

A computer proactively selects virtual reality (VR) content. The computer receives position metadata from a VR interaction device, the position metadata including a reference location. The computer receives bandwidth metadata for the reference location including available bandwidth values indexed to a timescale. The computer receives VR content requirement information which includes threshold values of available bandwidth to achieve acceptable performance for a plurality of VR content contexts. The computer receives at a reference time, a request for VR content delivery at a second, chronologically-later time. The computer selects before the occurrence of the second time, a VR content context having a threshold value of available bandwidth for acceptable performance below the available bandwidth value corresponding to the second time on the timescale.

### BACKGROUND

The present invention relates generally to the field of virtual reality (VR) systems, and more specifically, to a selecting content to be displayed in a VR interaction device.

VR systems can provide interactive experiences for users that simulate a variety of activities or contexts, including shopping (e.g., at virtual stores with multiple contexts), social interaction (e.g., sharing of experiences with others virtually), immersive gaming, and so on. VR systems consume large amounts of data, and the success of VR interaction requires enough available bandwidth to efficiently support elevated data transfer requirements.

Although VR systems generally consume large amounts of data, not all content and contexts have the same available bandwidth requirements (i.e., some content and contexts are more data-intensive than others). Contexts with graphics-rich content and especially-high resolution require particularly large amounts of available bandwidth, while static and graphically-simple content consume requires comparatively less available bandwidth.

For a variety of reasons, available bandwidth quantity can vary from location to location and, in some locations, even from one time of day to another. This variation can be especially troubling for users trying to experience contexts that require more bandwidth than is available at a particular location or time. This can create difficulties for users trying to efficiently and satisfactorily experience a series of contexts during a VR session that provides a variety of available bandwidth throughout the session. These problems can occur, for example, when a user moves through locations or time periods with large amounts of available bandwidth into locations or time periods with relatively low amounts available bandwidth. These difficulties can be especially problematic when trying to experience a series of contexts in light of varying context data requirements and changing bandwidth availability, because some content and certain contexts can only be successfully experienced at certain locations or at certain times.

### SUMMARY

In embodiments according to the present invention, a computer implemented method to proactively select virtual reality (VR) content includes receiving, by the computer, position metadata from a VR interaction device, said position metadata including a reference location. The computer receives bandwidth metadata for said reference location including available bandwidth values indexed to a timescale and receives VR content requirement information including threshold values of available bandwidth to achieve acceptable performance for a group of VR content contexts. The computer also receives, at a reference time, a request for VR content delivery at a second time later than the reference time. The computer also selects, before the occurrence of the second time, a VR content context having a threshold value of available bandwidth for acceptable performance below the available bandwidth value corresponding of the second time. According to other aspects, the selection is made, at least in part, in accordance with a preference value associated with said VR content contexts, said chosen from a list consisting of a specific user request, a commercial value, popularity, recency of a last visit by said VR interaction device. According to other aspects, the position metadata indicates that said VR interaction device will be in a second location at said second time, the computer receives bandwidth metadata for the second location including at least one available bandwidth value, and the VR content context is made, at least in part, in accordance with available bandwidth of the second location. According to other aspects, the position metadata includes information selected from a list consisting of movement speed, movement direction, and movement velocity. According to other aspects, the positioning metadata indicates that said VR interaction device will be in a third location at a third time, the computer receives bandwidth metadata for the third location, including available bandwidth values indexed to said timescale, the computer determines, before the occurrence of the third time, a mismatch condition in that the selected VR content context has a threshold value of available bandwidth for acceptable performance above the available bandwidth value at the third location at the third time, and responsive to determining the mismatch condition, before the occurrence of the third time, taking, by the computer, a corrective action. According to other aspects, the corrective action is selecting a second VR content context having a threshold value of available bandwidth for acceptable performance below the available bandwidth value at said third location at said third time. According to other aspects, the corrective action is suggesting, by said computer, to a user of said VR interaction device to arrive at said third location at a fourth time selected, at least in part, so that the threshold value of available bandwidth for acceptable performance for said selected VR content context is below the available bandwidth at said third location at said fourth time. According to other aspects, the corrective action is directing, by the computer, an autonomous positioning mechanism for the VR interaction device to arrive at the third location at a fourth time selected, at least in part, so that the threshold value of available bandwidth for acceptable performance for the selected VR content context is below the available bandwidth at the third location at the fourth time. According to other aspects, the position metadata indicates that said VR interaction device will be in a second location at the second time and at a third location at a third time, the computer receives bandwidth metadata for the second location, including available bandwidth values indexed by time, and the selection of the VR content context is made by the computer at least in part, in accordance with the available bandwidth value for the second location at the second time, the computer receives bandwidth metadata for the third location, including available bandwidth values indexed to the timescale, the computer selecting, before the occurrence of the third time, a second VR content context having a threshold value of available bandwidth for acceptable performance below the available bandwidth value at the third location, the selection of the second VR content context being made by the computer, at least in part, in accordance with the available bandwidth value for the third location at the third time. According to other aspects, the second VR content context is selected by the computer, at least in part in consideration of a preference value associated with said VR content contexts, said chosen from a list consisting of a specific user request, a commercial value, popularity, recency of a last visit by said VR interaction device. According to other aspects, the positioning metadata indicates the VR interaction device will be in the reference location at a third time and at a fourth time, the computer determines, before the occurrence of the third time, a mismatch condition in that the selected VR content context has a threshold value of available bandwidth for acceptable performance above the available bandwidth value at the reference location at the third time, the computer determines before the occurrence of the third time, a rematch condition in that the selected VR content context has a threshold value of available bandwidth for acceptable performance below the available bandwidth value at the reference location at the fourth time, the computer, in response to determining the mismatch condition and rematch condition, between the occurrence of the third time and until the occurrence of the fourth time, switching to a substitute VR content context having a threshold value of available bandwidth for acceptable performance below the available bandwidth value at the reference location at the third time.

According to another embodiment, a system to proactively selecting virtual reality (VR) content, includes a computer system comprising a computer readable storage medium having program instructions embodied therewith, the program instructions executable by a computer to cause the computer to: receive position metadata from a VR interaction device, said position metadata including a reference location; receive bandwidth metadata for said reference location including available bandwidth values indexed to a timescale; receive VR content requirement information which includes threshold values of available bandwidth to achieve acceptable performance for a plurality of VR content contexts; receive at a reference time, a request for VR content delivery at a second time, said second time being chronologically later than said reference time; and select before the occurrence of said second time, a VR content context having a threshold value of available bandwidth for acceptable performance below the available bandwidth value corresponding to said second time on said timescale.

According to another embodiment, a computer program product to proactively selecting virtual reality (VR) content, includes a computer readable storage medium having program instructions embodied therewith, the program instructions executable by a computer to cause the computer to: receive, using said computer, position metadata from a VR interaction device, said position metadata including a reference location; receive, using said computer, bandwidth metadata for said reference location including available bandwidth values indexed to a timescale; receive, using said computer, VR content requirement information which includes threshold values of available bandwidth to achieve acceptable performance for a plurality of VR content contexts; receive at a reference time, a request for VR content delivery at a second time, said second time being chronologically later than said reference time; and select, using said computer, before the occurrence of said second time, a VR content context having a threshold value of available bandwidth for acceptable performance below the available bandwidth value corresponding to said second time on said timescale.

The present disclosure recognizes the shortcomings and problems associated with trying to proactively coordinate VR context selection to match dynamic, yet historically known, bandwidth availability during a given VR session.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for a computer-implemented method of predictively selecting virtual reality content that proactively accommodates upcoming available bandwidth conditions according to embodiments of the present invention.

FIG. 2 is a flowchart illustrating a method, implemented using the system shown in FIG. 1, of predictively selecting virtual reality content that proactively accommodates upcoming available bandwidth conditions according to some aspects of the invention.

FIG. 3 is a flowchart illustrating a method, implemented using the system shown in FIG. 1, of predictively selecting virtual reality content that proactively accommodates upcoming available bandwidth conditions according to some aspects of the invention.

FIG. 4 is a flowchart illustrating a method, implemented using the system shown in FIG. 1, of predictively selecting virtual reality content that proactively accommodates upcoming available bandwidth conditions according to some aspects of the invention.

FIG. 5 is a flowchart illustrating a method, implemented using the system shown in FIG. 1, of predictively selecting virtual reality content that proactively accommodates upcoming available bandwidth conditions according to some aspects of the invention.

FIG. 6 is a flowchart illustrating a method, implemented using the system shown in FIG. 1, of predictively selecting virtual reality content that proactively accommodates upcoming available bandwidth conditions according to some aspects of the invention.

FIG. 7 is a table showing sample available bandwidth metadata for several locations and indexed to a timescale as implemented by some aspects of the invention.

FIG. 8 is a table illustrating showing exemplary available bandwidth thresholds for acceptable metadata performance for several VR content contexts, along with associated typical context session times, as implemented by some aspects of the invention.

FIG. 9 is a schematic representation of a map showing a reference location, a second location, a third location implemented according to some aspects of the invention.

FIG. 10 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 11 depicts a cloud computing environment according to an embodiment of the present invention.

FIG. 12 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

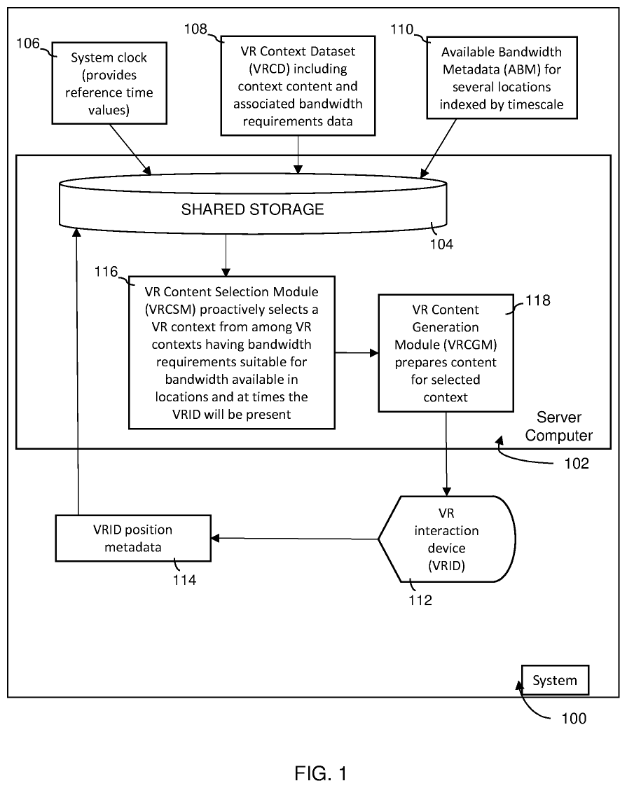

Now with combined reference to the Figures generally and with particular reference to FIG. 1, an overview of a method of predictively selecting virtual reality content usable within a system 100 as carried out by a server computer 102 having optionally shared storage 104 and aspects that proactively accommodate available bandwidth conditions, according to an embodiment of the present disclosure is shown. The server computer 102 is in communication with a system clock 106 that provides reference time values and consistent, chronological indexing for aspects of the present invention. A VR Context Dataset (VRCD) 108 provides context content and associated bandwidth requirements data. The server computer 102 is also in communication with a source of Available Bandwidth Metadata (ABM) 110. A VR Interaction Device 112 (VRID) provides VRID position metadata 114 that provides information about the VRID, including location, speed, travel direction, and possibly velocity, all of which can be indexed to reference times that used to coordinate with information provided by the system clock 106, in some aspects of the invention. A VR Content Selection Module (VRCSM) 116, as will be described more fully below, proactively selects a VR context from among VR contexts having bandwidth requirements suitable for bandwidth available in locations and at times the VRID 114 will be present. VR Content Generation Module (VRCGM) 118 prepares content for selected contexts and sends it to the VRID 114 to be experienced by a user (not shown).

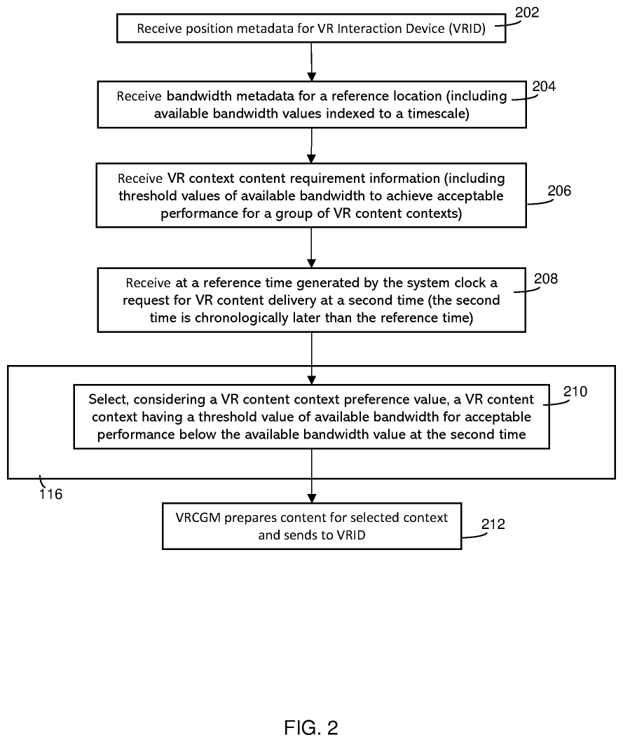

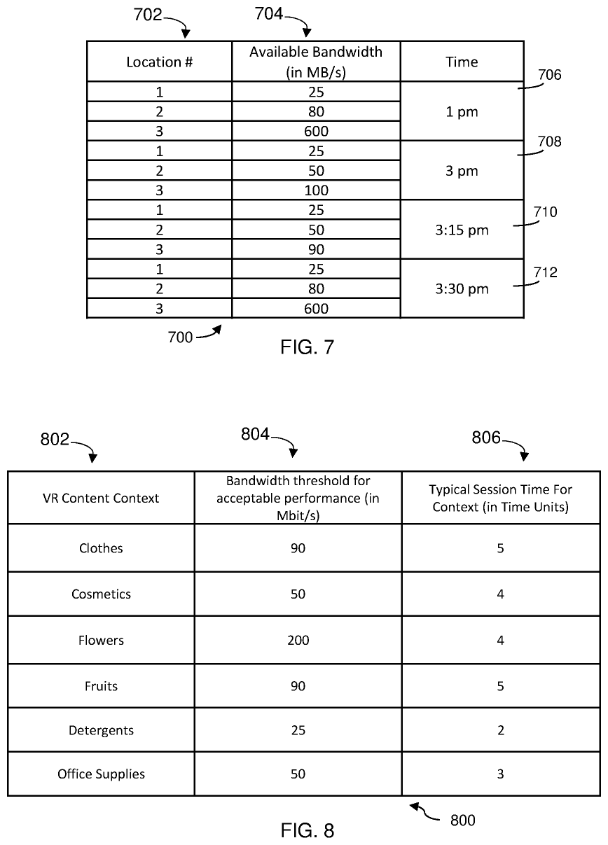

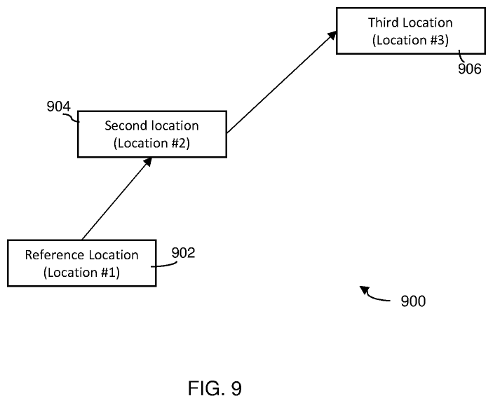

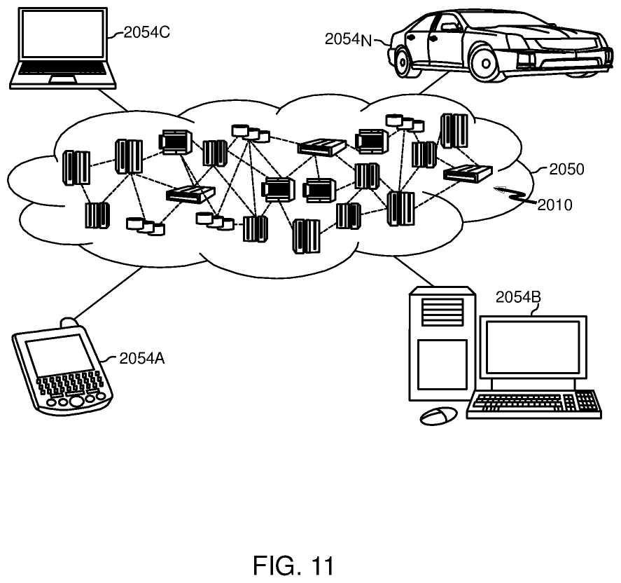

Now, with additional reference to FIG.2, aspects of a method useable within the system 100 described above to predictively select virtual reality content that proactively accommodates upcoming available bandwidth conditions according to some aspects of the invention will be discussed in detail. According to aspects of this embodiment, a user controlling a VRID 112 is in a location (e.g., a home, commercial building, airport, etc.) and wishes to conduct a virtual shopping trip. At block 202, the server computer 102 receives VRID position metadata 114, including a reference location 902 (seen best on map 900 in FIG. 11) for the VRID 112. At block 204, the server computer 102 receives bandwidth metadata 110 (shown in table 700 in FIG. 7) for several locations 702, including available bandwidth values 704 for each location, indexed to a timescale (e.g., representative reference time positions 706, 708, 710, 712) that corresponds to the timescale used by the system clock 106.

At block 206, the server computer 102 receives VR context content requirement information, including threshold values of available bandwidth to achieve acceptable performance for a group of VR content contexts. As used herein, the term “context” means a virtual setting similar to what might be experienced when undertaking an activity, such as shopping, in a brick-and-mortar (e.g., non-virtual) store. A brick-and-mortar store may have several departments or types of bundled goods (e.g., clothing, cosmetics, flowers, fruits, detergents, office supplies, and others as selected those skilled in this field) to experience during a given shopping session. The contexts (several of which are shown at 802 in table 800 shown in FIG. 8) may each have a distinct set of characteristics (e.g., levels of packaging content to process, appearance details, aspects to consider when making a purchase decision, time typically spent interacting with the product group during a given shopping session, and so on). As a result, representing different contexts in a virtual store will require different amounts of data. For example, virtual shopping in the context 802 of flowers may require bandwidth available at a rate above a threshold 804 for acceptable performance of 200 Mb/s, while a shopping in the context of detergents only needs 25 MB/s for acceptable performance. This is because the proper rendering of geometrically-simple rectangular packaging often found in the detergent context 802 uses much less data than the rendering of colorful and often highly-detailed flowers. In other words, the detergent context 802 has an available bandwidth threshold for acceptable performance that is lower than that of the flower context. According to FIG. 8, the detergent context 802 has an available bandwidth threshold value 804 of 25 MB/s, while the flowers context has an available bandwidth threshold value of 200 MB/s. It is noted that contexts 802 may vary and can be selected in accordance with the judgment of one skilled in this field. It is also noted that contexts 802 need not be limited to types of goods, and may also include gamification of a situation, collaboration, and other data consuming aspects that may enhance the experience of a within context, as selected by one skilled in this field.

Trying to portray contexts 802 when the available bandwidth 704 is lower than the respective context thresholds 804 will result in an unacceptable user experience. Therefore, in order to have a successful VR session, it is desired to only select contexts 802 with available bandwidth thresholds 804 below the available bandwidth 704. As noted above and as shown in FIG. 7, available bandwidth 704 can vary between locations 702 and even at different times 706, 708, 710, 712 for some locations (e.g., location #3).

With continued reference to FIG.2, the server computer 102 receives, in block 208, at a reference time 706 (e.g., 1 pm) generated by the system clock 106 a request for VR content delivery at a second, later, time 708 (e.g., 3 pm). To ensure a successful portrayal of context 802 at the second time 708, the server computer 102, uses the VRCSM 116 to ensure select a context with an available bandwidth threshold 804 for acceptable performance that is lower than the bandwidth 704 that will be available at the second time 708, in the reference location 902 (which FIG. 11 shows to be location #1). Therefore, the server computer 102 at block 210, selects, before the occurrence of the second time 708, a VR content context having a threshold value of available bandwidth for acceptable performance below the available bandwidth value in the reference location 902 at the second time.

It is noted that the server computer 102 may consider other factors in addition to available bandwidth and associated performance thresholds when selecting contexts to present. For example, the server computer may in various embodiments, also considering a VR content context preference value. According to aspect of various embodiments of this invention, the preference value can include a specific user request, a commercial value, popularity, recency of a last visit to a context by a given VR interaction device, and other factors selected by one skilled in this field. In this way, the server computer 102 can ensure that contexts 802 are selected in accordance with multiple factors if desired. This will, depending on a system profile, for example, allow users to guide context selection, allow content providers to encourage selection of contexts that are especially important commercially, and encourage context variety over one session to another. In this way, strategic preferences may be considered when selecting a context for portrayal from among several for which upcoming bandwidth availability is sufficient. If several preference values are indicated, they may be ranked so that certain preference values are given more influence than others.

It is noted that according to various aspects of embodiments included this invention, available bandwidth 704, in some embodiments, may be modified by attributes of a user account. These account attributes could include, standard vs. VIP status, free account vs. paid account, or other aspects chosen to raise or reduce bandwidth available to a given user, as selected by one skilled in this filed.

Once an appropriate context 802 (e.g., one for which upcoming bandwidth availability is sufficient to meet acceptable performance thresholds and which meet indicated preference value considerations) is selected, the sever computer via the VRCGM 118 at block 212, prepares content for selected context and sends the content to VRID 112 for interactive portrayal.

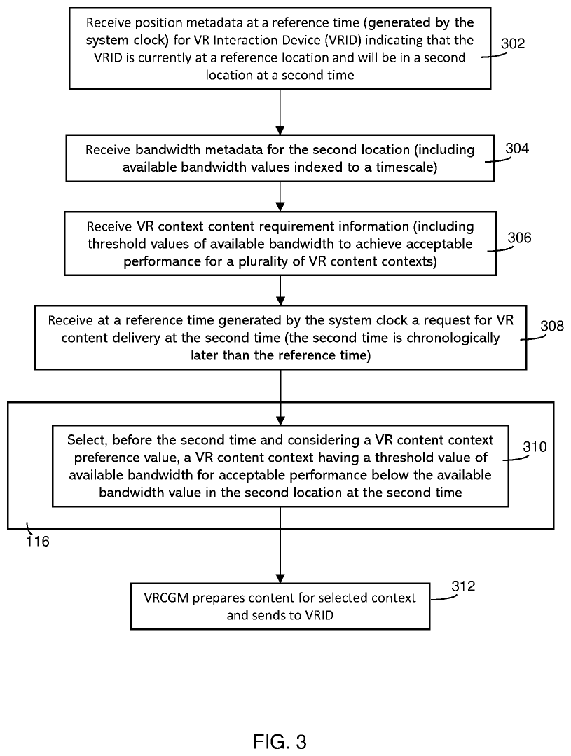

Now with additional reference to FIG. 3, aspects of a method useable within the system 100 described above to predictively select virtual reality content that proactively accommodates upcoming available bandwidth conditions according to some aspects of the invention will be discussed in detail. According to aspects of this embodiment, a user controlling a VRID 112 is in a reference location 902 (e.g., a home, commercial building, airport, etc.) and wishes to conduct a virtual shopping trip while traveling to a second location. At block 302, the server computer 102 receives VRID position metadata 114 at a reference time 706 (generated by the system clock) for VR Interaction Device (VRID) indicating that the VRID is currently at a reference location 902 and will be in a second location 904 at a second, chronologically later. time 708. The server computer 102, at block 304, receives bandwidth metadata 110 (shown in table 700 in FIG. 7) for the second location 904, including available bandwidth values 704 for the second location (which, according to aspects of this embodiment is location #2), indexed to a timescale (e.g., representative reference time positions 706, 708,710, 712) that corresponds to the timescale used by the system clock 106. The server computer, at block 306, receives VR context content requirement information, including threshold values of available bandwidth to achieve acceptable performance for a group of VR content contexts. The server computer 102, at block 308, receives at a reference time 706 generated by the system clock, a request for VR content delivery at the second time. The server computer 102, selects using the VRCSM 116 at block 310 to select, before the second time and considering VR content context preference values as described above, a VR content context 802 having a threshold value of available bandwidth for acceptable performance 804 below the available bandwidth value in the second location 904 at the second time 708. The server computer 102, via the VRCGM 118 at block 312, prepares content for selected context 804 and sends it to VRID 112 for interactive portrayal.

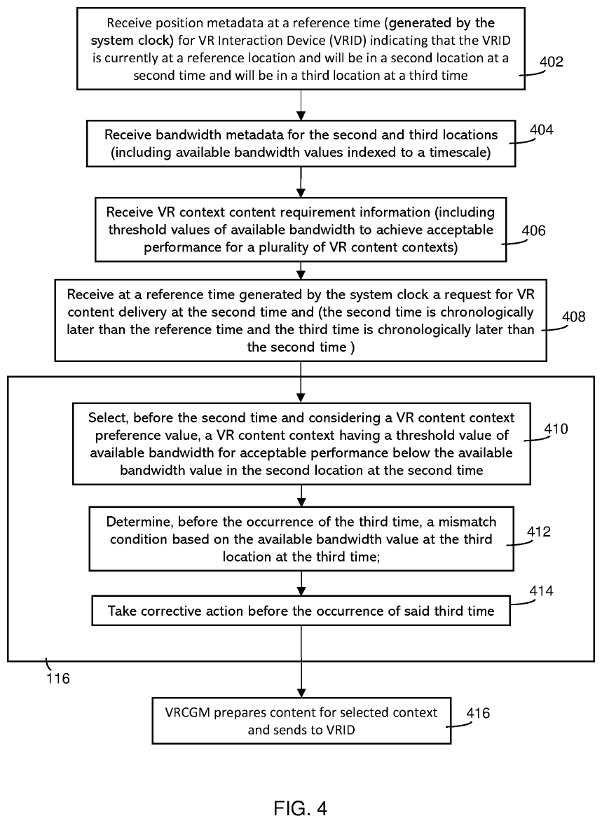

Now with additional reference to FIG. 4, aspects of a method useable within the system 100 described above to predictively select virtual reality content that proactively accommodates upcoming available bandwidth conditions according to some aspects of the invention will be discussed in detail. According to aspects of this embodiment, a travelling user controlling a VRID 112 will be in a reference location 902 (e.g., a home, commercial building, airport, etc.) at a reference time 706, will be in a second location 904 at a second time 708, and will be in a third location 906 at a third time 710. According to other aspects of this embodiment, the server computer detects and corrects a bandwidth mismatch condition as described more fully below. The sever computer 102, at block 402, receives position metadata at a reference time 702 for the VRID 112 indicating the VRID is currently at a reference location 902 and will be in a second location 904 a second time 708 and will be in a third location 906 at a third time 710. The server computer 102, at block 404, receives bandwidth metadata for the second and third locations 904,906 including available bandwidth values 704 indexed to the timescale used by the system clock 106. The server computer 102, at block 406, receives VR context content requirement information including threshold values of available bandwidth 804 to achieve acceptable performance for a plurality of VR content contexts 802. The server computer 102, receives at a reference time 706 generated by the system clock 106 a request for VR content delivery at the second time 708. According to aspects of this embodiment, the second time 708 is chronologically later than the reference time 706, and the third time 710 is chronologically later than the second time. The server computer 102, via the VRCSM 116, proactively selects appropriate contexts for the upcoming location 904,906 at the associated upcoming times 708,710. The server computer 102, at block 410, selects before the second time 708 and considering relevant VR content context preference value (as discussed above), a VR content context 802 having a threshold value of available bandwidth 804 for acceptable performance below the available bandwidth value 704 in the second location 904 at the second time. The server computer 102, at block 412, proactively determines, before the occurrence of the third time 710, a mismatch condition based on the available bandwidth value 704 at the third location 906 at the third time 710. As used herein, the term “mismatch condition” means a situation in which the bandwidth threshold for acceptable performance 804 will be above the available bandwidth 704 for the selected context to be satisfactorily portrayed at a location where the VRID 112 will be located at an upcoming time. To ensure a satisfactory VR session, the server computer 102, at block 414, takes corrective action before the occurrence of the third time 710. According to an aspect of the invention, corrective action may include selecting a second VR content context having a threshold value of available bandwidth for acceptable performance below the available bandwidth value at the third location 906 at the third time 710. According to another aspect of the invention, corrective action may include suggesting to a user of said VR interaction device to arrive at the third location 906 at a fourth time 712 selected, at least in part, so that the threshold value of available bandwidth 804 for acceptable performance for the selected VR content context 802 is below the available bandwidth 704 at said third location 906 at the fourth time 712 (e.g., a time later than the third time 710. According to another aspect of the invention, corrective action may include directing an autonomous positioning mechanism (not shown) for the VRID 112 to arrive at the third location 906 at a fourth time 712 selected, at least in part, so that the threshold value 804 of available bandwidth for acceptable performance for said selected VR content context 802 is below the available bandwidth 704 at the third location 906 at the fourth time 712. Other corrective actions may be selected by one skilled in this field. Once the server computer 102 has proactively addressed the noted mismatch condition, the server computer 102, via the VRCGM 118 at block 416, prepares content for the selected contexts 802 and sends to them to the VRID 112 for interactive portrayal at the associated scheduled times 708,710,712. It is noted that mismatch conditions can occur for a variety of reasons, including a user taking more time than expected 806 for a given context 802 or requesting to repeat portrayal of a previously portrayed context.

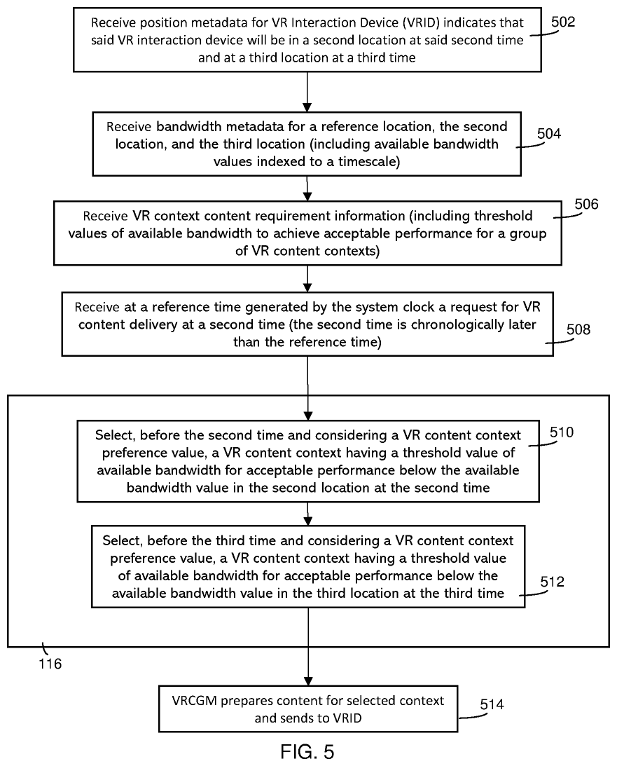

Now with additional reference to FIG. 5, aspects of a method useable within the system 100 described above to predictively select virtual reality content that proactively accommodates upcoming available bandwidth conditions according to some aspects of the invention will be discussed in detail. According to aspects of this embodiment, a travelling user controlling a VRID 112 will be in a location (e.g., a home, commercial building, airport, etc.) at a reference time 706, will be at a second location 904 at a second time 708 and will be at a third location 906 at a third time 708. and will be at a third location 906 at a third time 710. This situation might occur when a user is travelling along a predetermined route according to a predetermined schedule (e.g., using scheduled public transportation, scheduled rail transport, travel along a known route, such a road or navigable waterway at predetermined speed). According to aspects of this embodiment, the server computer 102 proactively avoids mismatch conditions as the VRID 112 moves through different locations 902,904,906 at known times 706,708,710. The server computer 102, at block 502, receive position metadata for VRID 112 indicating that the VRID will be in a second location 904 at a second time 708 and at a third location 906 at a third time 710. The server computer 102, at block 504, receives bandwidth metadata for a reference location 902, the second location 904, and the third location 906, including available bandwidth values for each location indexed to the timescale used by the system clock 106. The server computer 102, at block 506, receive VR context content requirement information including threshold values 804 of available bandwidth to achieve acceptable performance for several VR content contexts 802. The server computer 102, at block 508, receives at a reference time 706 generated by the system clock, a request for VR content delivery at a second time 708. According to aspects of the second time 708 is chronologically later than the reference time 706. To ensure satisfactory content portrayal throughout a VR use session (e.g., during a trip), the server computer 102, via VRCSM) 116 proactively selects content matching available bandwidth for known locations 902, 904, 906 at known upcoming times 706,708,710. It is noted that, as discussed above, the server computer 102 may also consider context preference values when selecting content to portray. The server computer 102, at block 510 selects, before the second time 708 and considering any relevant VR content context preference values, a VR content context 802 having a threshold value 804 of available bandwidth for acceptable performance below the available bandwidth value in the second location 904 at the second time. The server computer 102, at block 512 selects, before the third time 710 and considering any relevant VR content context preference values, a VR content context 802 having a threshold value 804 of available bandwidth for acceptable performance below the available bandwidth value 704 in the third location 906 at the third time 710. Once the server computer 102 has proactively selected appropriate contexts 802, the server computer 102, via the VRCGM 118 at block 514, prepares content for the selected contexts 802 and sends to them to the VRID 112 for interactive portrayal at the associated scheduled times 708,710.

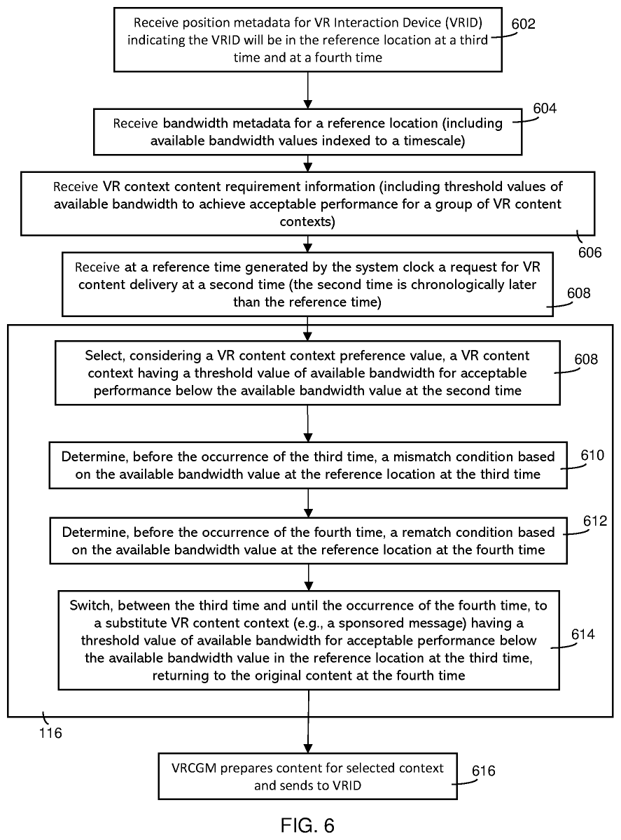

Now with additional reference to FIG. 6, aspects of a method useable within the system 100 described above to predictively select virtual reality content that proactively accommodates upcoming available bandwidth conditions according to some aspects of the invention will be discussed in detail. According to aspects of this embodiment, a user controlling a VRID 112 will be in a reference location 902 (e.g., a home, commercial building, airport, etc.) at a reference time 706, during a second time 708, through a third time 710, and at least until a fourth time. According to other aspects of this embodiment, the server computer detects and addresses a bandwidth mismatch condition between the third and fourth times as described more fully below. The server computer 102, at block 602, receives position metadata for VRID 112 indicating that the VRID will be at the reference location 902 (in addition to the reference time 706 and a second time 708) at a third time 710 and a fourth time 712. The server computer 102, at block 606, receives VR context content requirement information, including threshold values 804 of available bandwidth to achieve acceptable performance for a group of VR content contexts 802. The server computer 102, at block 608, receives at a reference time 706 generated by the system clock 106, a request for VR content delivery at a second time 708. According to aspects of this embodiment, the second time 708 is chronologically later than the reference time 706, the third time 710 is chronologically later than the second time, and the fourth time 712 is chronologically later than the third time. To ensure satisfactory content portrayal throughout a VR use session (e.g., during an extended stay at a reference location), the server computer 102, via VRCSM 116 proactively selects content matching available bandwidth for the reference location 902 at known upcoming times 706,708,710,712. It is noted that, as discussed above, the server computer 102 may also consider context preference values when selecting content to portray. The server computer 102 at block 608 selects, considering any relevant VR content context preference values, a VR content context having a threshold value 804 of available bandwidth for acceptable performance below the available bandwidth value 704 at the second time 708. The server computer 102, at block 610, determines, before the occurrence of the third time 710, a mismatch condition (as described above) based on the available bandwidth value 704 at the reference location 902 at the third time 710. The server computer 102, at block 612, determines before the occurrence of the fourth time 712, a rematch condition based on the available bandwidth value 704 at the reference location 902 at the fourth time. As used herein, the term “mismatch condition” means a situation in which available bandwidth 704 increases and the bandwidth threshold 804 for acceptable performance will as it was previously, be below the available bandwidth 704. As a result, the selected context 802 can be satisfactorily portrayed at a location where the VRID 112 will be located at an upcoming time. The server computer 102, at block 614, will switch from portraying the originally-selected 802 between the third time 710 and until the occurrence of the fourth time 712, to a substitute VR content context (e.g., a sponsored message) having a threshold value of available bandwidth for acceptable performance below the available bandwidth value in the reference location 902 at the third time 710. The server computer 102 will select another context (possibly returning to the originally-selected context) for portrayal when the fourth time 712 occurs. The server computer 102, at block 616 Once the server computer 102 has proactively selected content to during the noted mismatch condition at the third time 710 and rematch condition at the fourth time 712, the server computer 102, via the VRCGM 118 at block 416, prepares content for the selected contexts 802 and sends to them to the VRID 112 for interactive portrayal at the associated scheduled times 708,710,712.

Table 800 also shows that different relative amounts of time 806 can be typically used when shopping in various contexts. For example, buying fruit, which requires an assessment of ripeness, is shown to involve 5 time units per session, while shopping for more fungible products (e.g., office supplies) is shown to require only 3 time units per session. This is used by the server computer 102 to determine expected appropriate schedules during trips across several locations or during several time periods, allowing for contexts typically needed large amounts of time to be scheduled necessary bandwidth quantities are available. This expected time to be spent for a given context can be considered as one of the preference values used in the manner discussed above when from selecting from among selecting viable contexts.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

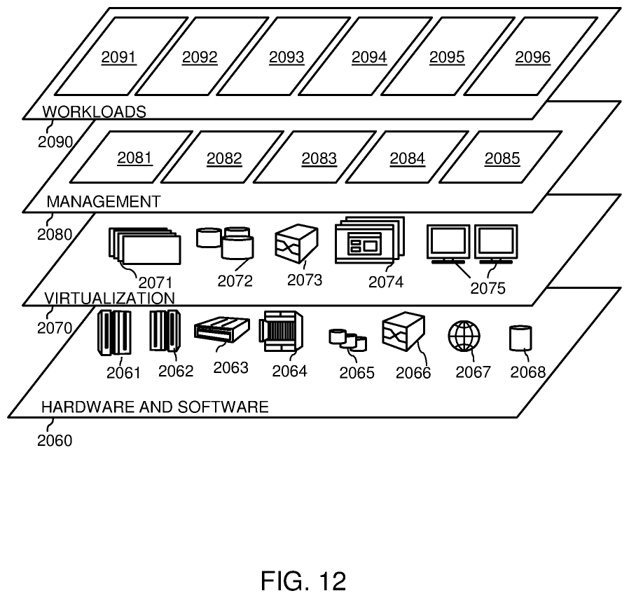

Referring to FIG. 12, a system or computer environment 1000 includes a computer diagram 1010 shown in the form of a generic computing device. The method 100, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

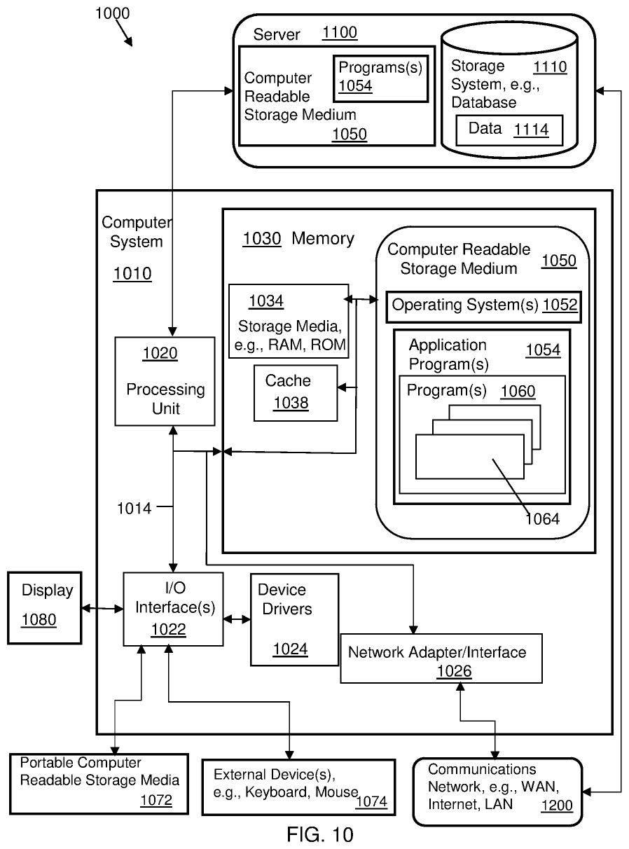

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 (shown in FIG. 10) can include all or part of the computer system 1010 and its components, and/or the control system can communicate with all or part of the computer system 1010 and its components as a remote computer system, to achieve the control system functions described in the present disclosure. It is also understood that the one or more communication devices 110 shown in FIG. 1 similarly can include all or part of the computer system 1010 and its components, and/or the communication devices can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 11, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 11 are intended to be illustrative only and that computing nodes 2010 and cloud computing environment 2050 can communicate with any type of computerized device over any type of network and/or network addressable connection (e.g., using a web browser).

Referring now to FIG. 12, a set of functional abstraction layers provided by cloud computing environment 2050 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and predictively selecting virtual reality content that proactively accommodates upcoming available bandwidth conditions 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method to proactively select virtual reality (VR) content comprising:
receiving, by said computer, position metadata from a VR interaction device (VRID), said position metadata including a reference location and position metadata for the VRID indicating that the VRID will be in a second location at a second time and at a third location at a third time;
receiving, by said computer, bandwidth metadata for said reference location, the second location, and the third location, including available bandwidth values for the respective locations indexed to a timescale;
receiving, by said computer, VR content requirement information which includes threshold values of available bandwidth to achieve acceptable virtual element rendering performance for a plurality of VR content contexts;
receiving, by said computer, at a reference time, a request for VR content delivery at the second time and at the third time, the second time being chronologically later than said reference time, and the third time being chronologically later than the second time;
selecting, by said computer, before the occurrence of said second time and based at least in part on satisfying associated context threshold values of available bandwidth to achieve acceptable virtual element rendering performance, a second VR content context having a threshold value of available bandwidth for acceptable virtual element rendering performance below the available bandwidth value in the second location at said second time on said timescale;
selecting, by said computer, before the occurrence of said third time and based at least in part on satisfying associated context threshold values of available bandwidth to achieve acceptable virtual element rendering performance, a third VR content context having a threshold value of available bandwidth for acceptable virtual element rendering performance below the available bandwidth value in the third location at said third time on said timescale;
responsive to selecting the first and second VR content contexts, preparing by the server computer, respective second and third context content; and
sending, by the server computer, the second and third context content to the VRID at the associated scheduled second and third times,
whereby the server computer proactively selects content matching available bandwidth of the second and third known locations at known second and third times, thereby ensuring satisfactory content portrayal during a VR use session, with content matching available bandwidth of known locations at known upcoming times that are subsequent to the reference time.

2. The method of claim 1, wherein said selection is made, at least in part, in accordance with a preference value associated with said VR content contexts, said preference value chosen from a list consisting of a specific user request, a commercial value, popularity, recency of a last visit by said VR interaction device.

3. The method of claim 1, wherein:
said position metadata indicates that said VR interaction device will be in a second location at said second time;
receiving, by said computer, bandwidth metadata for said second location including at least one available bandwidth value; and
said selection of said VR content context is made, at least in part, in accordance with said at least one available bandwidth value of said second location.

4. The method of claim 3, wherein said position metadata includes information selected from a list consisting of movement speed, movement direction, and movement velocity.

5. The method of claim 3, wherein:
said positioning metadata indicates that said VR interaction device will be in a third location at a third time;
receiving, by said computer, bandwidth metadata for said third location including available bandwidth values indexed to said timescale;
determining, by said computer, before the occurrence of said third time, a mismatch condition wherein said selected VR content context has a threshold value of available bandwidth for acceptable performance above the available bandwidth value at said third location at said third time; and
responsive to said determination of said mismatch condition, before the occurrence of said third time, taking, by said computer, a corrective action.

6. The method of claim 5, wherein said corrective action is selected from a list consisting of:
selecting a second VR content context having a threshold value of available bandwidth for acceptable performance below the available bandwidth value at said third location at said third time;
suggesting, by said computer, to a user of said VR interaction device to arrive at said third location at a fourth time selected, at least in part, so that the threshold value of available bandwidth for acceptable performance for said selected VR content context is below the available bandwidth at said third location at said fourth time; and
directing, by said computer, an autonomous positioning mechanism for said VR interaction device to arrive at said third location at a fourth time selected, at least in part, so that the threshold value of available bandwidth for acceptable performance for said selected VR content context is below the available bandwidth at said third location at said fourth time.

7. The method of claim 1, wherein:
said position metadata indicates that said VR interaction device will be in a second location at said second time and at a third location at a third time;
receiving, by said computer, bandwidth metadata for said second location including available bandwidth values indexed to said timescale;
wherein said selection of said VR content context is made by said computer at least in part, in accordance with the available bandwidth value for said second location at said second time on said timescale;
receiving, by said computer, bandwidth metadata for said third location including available bandwidth values indexed to said timescale;
selecting, by said computer, before the occurrence of said third time, a second VR content context having a threshold value of available bandwidth for acceptable performance below the available bandwidth value at said third location; and
wherein said selection of said second VR content context is made by said computer, at least in part, in accordance with the available bandwidth value for said third location at said third time on said timescale.

8. The method of claim 7, wherein said second VR content context is selected by said computer, at least in part in consideration of a preference value associated with said VR content contexts, said preference value chosen from a list consisting of a specific user request, a commercial value, popularity, recency of a last visit by said VR interaction device.

9. The method of claim 1, wherein:
said positioning metadata indicates that said VR interaction device will be in said reference location at a third time and a fourth time;
determining by said computer, before the occurrence of said third time, a mismatch condition wherein said selected VR content context has a threshold value of available bandwidth for acceptable performance above the available bandwidth value at said reference location at said third time;
determining by said computer, before the occurrence of said third time, a rematch condition wherein said selected VR content context has a threshold value of available bandwidth for acceptable performance below the available bandwidth value at said reference location at said fourth time; and
responsive to said determination of said mismatch condition and said rematch condition, between the occurrence of said third time and until the occurrence of said fourth time, switching to a substitute VR content context having a threshold value of available bandwidth for acceptable performance below the available bandwidth value at said reference location at said third time.

10. The method of claim 9, wherein:
said substitute VR content context includes a sponsored message; and
said computer switches back to said originally selected selected VR content context at said fourth time.

11. A system for proactively selecting virtual reality (VR) content, which comprises:
a computer system comprising a computer readable storage medium having program instructions embodied therewith, the program instructions executable by a computer to cause the computer to:
receive position metadata from a VR interaction device (VRID), said position metadata including a reference location and position metadata for the VRID indicating that the VRID will be in a second location at a second time and at a third location at a third time;
receive bandwidth metadata for said reference, the second location, and the third location, location including available bandwidth values for the respective locations indexed to a timescale;
receive VR content requirement information which includes threshold values of available bandwidth to achieve acceptable virtual element rendering performance for a plurality of VR content contexts;
receive at a reference time, a request for VR content delivery at the second time and at the third time, the second time being chronologically later than said reference time, and the third time being chronologically later than the second time;
select before the occurrence of said second time and based at least in part on satisfying associated context threshold values of available bandwidth to achieve acceptable virtual element rendering performance, a second VR content context having a threshold value of available bandwidth for acceptable virtual element rendering performance below the available bandwidth value in the second location at said second time on said timescales.
select, before the occurrence of said third time and based at least in part on satisfying associated context threshold values of available bandwidth to achieve acceptable virtual element rendering performance, a third VR content context having a threshold value of available bandwidth for acceptable virtual element rendering performance below the available bandwidth value in the third location at said third time on said timescale;
responsive to selecting the first and second VR content contexts, prepare respective second and third context content; and
send the second and third context content to the VRID at the associated scheduled second and third times,
whereby the server computer proactively selects content matching available bandwidth of the second and third known locations at known second and third times, thereby ensuring satisfactory content portrayal during a VR use session, with content matching available bandwidth of known locations at known upcoming times that are subsequent to the reference time.

12. The system of claim 11 wherein:
said position metadata indicates that said VR interaction device will be in a second location at said second time;
said instructions further cause said computer to receive bandwidth metadata for said second location including at least one available bandwidth value; and
said selection of said VR content context is made, at least in part, in accordance with said at least one available bandwidth value of said second location.

13. The system of claim 12 wherein:
said positioning metadata indicates that said VR interaction device will be in a third location at a third time;
said instruction further cause said computer to receive bandwidth metadata for said third location including available bandwidth values indexed to said timescale;
determine before the occurrence of said third time, a mismatch condition wherein said selected VR content context has a threshold value of available bandwidth for acceptable performance above the available bandwidth value at said third location at said third time; and
responsive to said determination of said mismatch condition, before the occurrence of said third time, take a corrective action.

14. The system of claim 13, wherein said corrective action is selected from a list consisting of:
causing said computer to select a second VR content context having a threshold value of available bandwidth for acceptable performance below the available bandwidth value at said third location at said third time;
causing said computer to suggest to a user of said VR interaction device to arrive at said third location at a fourth time selected, at least in part, so that the threshold value of available bandwidth for acceptable performance for said selected VR content context is below the available bandwidth at said third location at said fourth time; and
causing said computer to direct an autonomous positioning mechanism for said VR interaction device to arrive at said third location at a fourth time selected, at least in part, so that the threshold value of available bandwidth for acceptable performance for said selected VR content context is below the available bandwidth at said third location at said fourth time.

15. The system of claim 11, wherein:
said position metadata indicates that said VR interaction device will be in a second location at said second time and at a third location at a third time;
said instructions further causing said computer to receive bandwidth metadata for said second location including available bandwidth values indexed to said timescale;
wherein said selection of said VR content context is made at least in part, in accordance with the available bandwidth value for said second location at said second time on said timescale;
receive bandwidth metadata for said third location including available bandwidth values indexed to said timescale;
select before the occurrence of said third time, a second VR content context having a threshold value of available bandwidth for acceptable performance below the available bandwidth value at said third location; and
wherein said selection of said second VR content context is made by said computer, at least in part, in accordance with the available bandwidth value for said third location at said third time on said timescale.

16. The system of claim 11, wherein:
said positioning metadata indicates that said VR interaction device will be in said reference location at a third time and a fourth time;
said instructions further causing said computer to determine, before the occurrence of said third time, a mismatch condition wherein said selected VR content context has a threshold value of available bandwidth for acceptable performance above the available bandwidth value at said reference location at said third time;
determine before the occurrence of said third time, a rematch condition wherein said selected VR content context has a threshold value of available bandwidth for acceptable performance below the available bandwidth value at said reference location at said fourth time; and
responsive to said determination of said mismatch condition and said rematch condition, between the occurrence of said third time and until the occurrence of said fourth time, switch to a substitute VR content context having a threshold value of available bandwidth for acceptable performance below the available bandwidth value at said reference location at said third time.

17. A computer program product for proactively selecting virtual reality (VR) content, the computer program product comprising a computer readable storage medium having program instructions embodied therewith, the program instructions executable by a computer to cause the computer to:
receive, using said computer, position metadata from a VR interaction device (VRID), said position metadata including a reference location and position metadata for the VRID indicating that the VRID will be in a second location at a second time and at a third location at a third time;
receive, using said computer, bandwidth metadata for said reference, the second location, and the third location, location including available bandwidth values for the respective locations indexed to a timescale;
receive, using said computer, VR content requirement information which includes threshold values of available bandwidth to achieve acceptable virtual element rendering performance for a plurality of VR content contexts;
receive at a reference time, a request for VR content delivery at the second time and at the third time, the second time being chronologically later than said reference time, and the third time being chronologically later than the second time;
select, using said computer, before the occurrence of said second time and based at least in part on satisfying associated context threshold values of available bandwidth to achieve acceptable virtual element rendering performance, a second VR content context having a threshold value of available bandwidth for acceptable virtual element rendering performance below the available bandwidth value in the second location at said second time on said timescale;
select, before the occurrence of said third time and based at least in part on satisfying associated context threshold values of available bandwidth to achieve acceptable virtual element rendering performance, a third VR content context having a threshold value of available bandwidth for acceptable virtual element rendering performance below the available bandwidth value in the third location at said third time on said timescale;
responsive to selecting the first and second VR content contexts, preparing respective second and third context content; and
send the second and third context content to the VRID at the associated scheduled second and third times,
whereby the server computer proactively selects content matching available bandwidth of the second and third known locations at known second and third times, thereby ensuring satisfactory content portrayal during a VR use session, with content matching available bandwidth of known locations at known upcoming times that are subsequent to the reference time.

18. The computer program product of claim 17, wherein:
said position metadata indicates that said VR interaction device will be in a second location at said second time;
said instructions further cause said computer to receive bandwidth metadata for said second location including at least one available bandwidth value; and
said selection of said VR content context is made, at least in part, in accordance with said at least one available bandwidth value of said second location.

19. The computer program product of claim 17, wherein:
said position metadata indicates that said VR interaction device will be in a second location at said second time and at a third location at a third time;
said instructions further causing said computer to receive bandwidth metadata for said second location including available bandwidth values indexed to said timescale;
wherein said selection of said VR content context is made at least in part, in accordance with the available bandwidth value for said second location at said second time on said timescale;
receive, using said computer, bandwidth metadata for said third location including available bandwidth values indexed to said timescale;
select, using said computer, before the occurrence of said third time, a second VR content context having a threshold value of available bandwidth for acceptable performance below the available bandwidth value at said third location; and
wherein said selection of said second VR content context is made by said computer, at least in part, in accordance with the available bandwidth value for said third location at said third time on said timescale.

20. The computer program product of claim 17, wherein:
said positioning metadata indicates that said VR interaction device will be in said reference location at a third time and a fourth time;
said instructions further causing said computer to determine, before the occurrence of said third time, a mismatch condition wherein said selected VR content context has a threshold value of available bandwidth for acceptable performance above the available bandwidth value at said reference location at said third time;
determine before the occurrence of said third time, a rematch condition wherein said selected VR content context has a threshold value of available bandwidth for acceptable performance below the available bandwidth value at said reference location at said fourth time; and
responsive to said determination of said mismatch condition and said rematch condition, between the occurrence of said third time and until the occurrence of said fourth time, switch to a substitute VR content context having a threshold value of available bandwidth for acceptable performance below the available bandwidth value at said reference location at said third time.
